(19) United States
(12) Patent Application Publication
(10) Pub. No.: US 2012/0307192 A1
(43) Pub. Date: Dec. 6, 2012

(54) DISPLAY DEVICE

(75) Inventors: Naohisa ANDOU, Mobara (JP); Takahiko Muneyoshi, Chiba (JP)

(73) Assignee: Hitachi Displays, Ltd.,

(21) Appl. No.: 13/483,075

(22) Filed: May 30, 2012

(30) Foreign Application Priority Data
Jun. 2, 2011 (JP) 2011-124623

(51) Int. Cl. G02F 1/1339

(52) U.S. Cl. 349/153

(57) ABSTRACT

Provided is a display device including: a pair of light transmissive substrates which are arranged so as to be opposed to each other at an interval; a sealing member for adhering the pair of light transmissive substrates to each other; oil filled in an encapsulation space; and a shutter formed on one of the pair of light transmissive substrates and arranged in the encapsulation space, in which the sealing member has a thermal expansion coefficient α larger than a thermal expansion coefficient β of the oil, or a relationship of 0.8β≦α≦1.2β is satisfied therebetween.

### CROSS-REFERENCE TO RELATED APPLICATION

The present application claims priority from Japanese application JP 2011-124623 filed on Jun. 2, 2011, the contents of which are hereby incorporated by reference into this application.

### BACKGROUND OF THE INVENTION

1. Field of the Invention

The present invention relates to a display device, and more particularly, to a display device which uses micro-electro-mechanical systems (MEMS) for pixels.

2. Description of the Related Art

A micro-electro-mechanical system (MEMS) display is a display expected to replace a liquid crystal display (see Japanese Patent Application Laid-open No. 2008-197668). This display differs from a liquid crystal shutter type display utilizing polarization, and performs light-dark display by opening and closing a light transmissive window using a mechanical shutter system. A mechanical shutter (hereinafter, simply referred to as shutter) is formed of an amorphous silicon film. Vertical and horizontal sizes of one shutter forming one pixel are in the order of several hundred micrometers, and a thickness thereof is in the order of several micrometers. One shutter is opened/closed to enable ON/OFF operation for one pixel. The shutter is operated by an electrostatic attractive force.

Oil is filled inside a panel in which the shutter operates, and the oil increases the dielectric constant in the panel, to thereby reduce a voltage necessary for driving the shutter. In this structure, there has been a problem that, due to oil contraction which occurs when an environmental temperature decreases, air bubbles are generated inside the panel (in a region filled with oil).

### SUMMARY OF THE INVENTION

The present invention has an object to prevent generation of air bubbles in oil filling a panel in which a mechanical shutter is arranged.

According to an exemplary embodiment of the present invention, there is provided a display device, including: a pair of insulating substrates which are arranged so as to be opposed to each other at an interval; a sealing member for adhering the pair of insulating substrates to each other; a shutter formed on one of the pair of insulating substrates; an encapsulation space defined by the pair of insulating substrates and the sealing member; and oil filled in the encapsulation space. The shutter is arranged in the encapsulation space. The sealing member has a thermal expansion coefficient larger than a thermal expansion coefficient of the oil.

Further, in the display device according to the exemplary embodiment of the present invention, the thermal expansion coefficient of the sealing member may be equal to the thermal expansion coefficient of the oil.

Still further, in the display device according to the exemplary embodiment of the present invention, the following relationship may be satisfied,

0.8β≦α≦1.2β,

where α represents a thermal expansion coefficient of the sealing member, and β represents a thermal expansion coefficient of the oil.

According to the present invention, a difference between the thermal expansion coefficient α of the sealing member and the thermal expansion coefficient β of the oil is small. Therefore, when an environmental temperature decreases, the sealing member contracts in accordance with contraction of the oil, and the encapsulation space contracts in accordance with the contraction of the sealing member. In this manner, the difference in volume between the encapsulation space and the oil reduces, and hence it is possible to prevent generation of air bubbles in the oil.

### BRIEF DESCRIPTION OF THE DRAWINGS

In the accompanying drawings:

FIG. 1 is a sectional view schematically illustrating a display device according to embodiments of the present invention;

FIG. 2 is a view illustrating a shutter and a drive portion thereof; and

FIG. 3 is an enlarged sectional view illustrating a light shielding film and an aperture portion thereof.

### DETAILED DESCRIPTION OF THE INVENTION

### First Embodiment

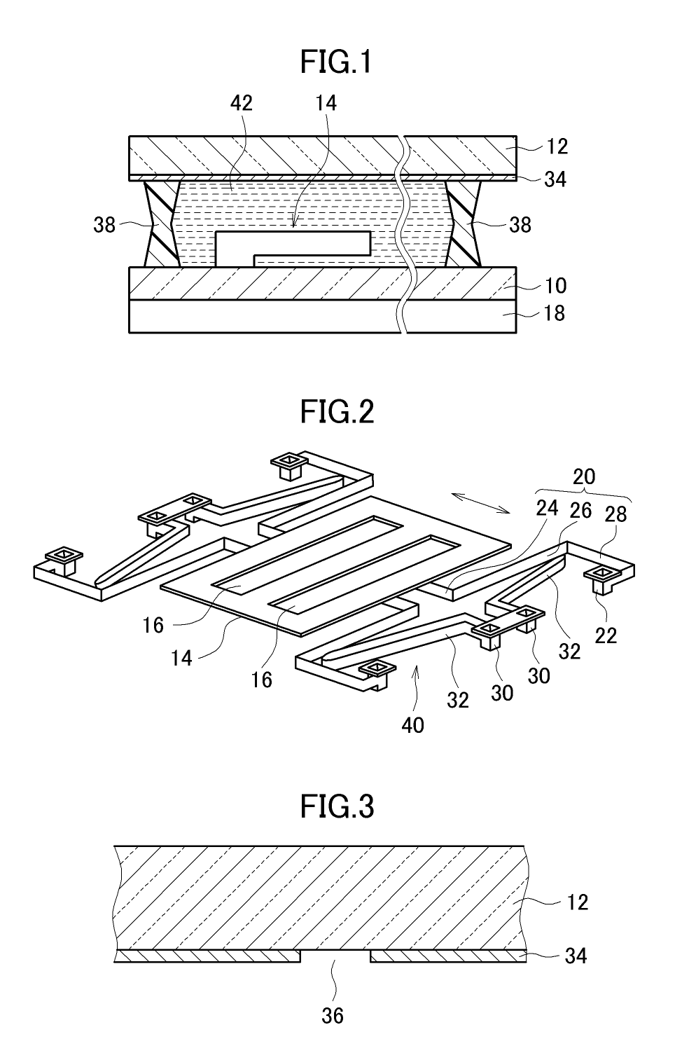

Hereinafter, embodiments of the present invention are described with reference to the drawings. FIG. 1 is a sectional view schematically illustrating a display device according to the embodiments of the present invention.

The display device includes a pair of light transmissive substrates (insulating substrates) 10 and 12 (for example, glass substrates). The pair of light transmissive substrates 10 and 12 are arranged so as to be opposed to each other at an interval.

A shutter 14 illustrated in FIG. 2 is provided on one light transmissive substrate 10 (on the lower side of FIG. 1). The shutter 14 is a plate including an aperture portion 16. Light is allowed to pass through the aperture portion 16, and is blocked at a part other than the aperture portion 16. The aperture portion 16 has a shape long in one direction. Note that, as illustrated in FIG. 1, light is supplied from a backlight unit 18 lying under the light transmissive substrate 10. Note that, in FIG. 1, the backlight unit 18 is arranged so as to be opposed to the light transmissive substrate 10 on which the shutter 14 is provided, but may be arranged so as to be opposed to the other light transmissive substrate 12.

The shutter 14 is supported by a first spring 20 to be suspended above the light transmissive substrate 10, that is, the shutter 14 is arranged so as to have a predetermined gap with respect to a main surface of the light transmissive substrate 10. A plurality of (four in FIG. 2) first springs 20 support the shutter 14. The first spring 20 is fixed to the light transmissive substrate 10 by a first anchor portion 22.

The first spring 20 is made of an elastically deformable material, and is arranged so as to be deformable in a direction parallel to the plate surface (main surface of the plate) of the shutter 14. Specifically, the first spring 20 includes a first portion 24 extending in a direction separating from the shutter (direction intersecting (for example, orthogonal to) the longitudinal direction of the aperture portion 16), a second portion 26 extending in a direction along the longitudinal direction of the aperture portion 16 outwardly from a center of the aperture portion 16 in the longitudinal direction, and a third portion 28 further extending in the direction separating from the shutter 14 (direction intersecting (for example, orthogonal to) the longitudinal direction of the aperture portion 16). Further, as indicated by the arrows in FIG. 2, the shutter 14 is movable in the direction intersecting (for example, orthogonal to) the longitudinal direction of the aperture portion 16.

The light transmissive substrate 10 is provided with a second spring 32 supported by a second anchor portion 30. The second spring 32 is opposed to the second portion 26 of the first spring 20 on a side separated from the shutter 14 with respect to the second portion 26. When a voltage is applied to the second anchor portion 30, due to the electrostatic attractive force caused by the potential difference between the second anchor portion 30 and the second portion 26 of the first spring 20, the second portion 26 is attracted toward the second spring 32. When the second portion 26 is attracted, the shutter 14 is also attracted via the first portion 24 provided integrally with the second portion 26. That is, the first spring 20 and the second spring 32 are provided for constituting a drive portion 40 for mechanically driving the shutter 14.

The other light transmissive substrate 12 has a light shielding film 34 formed thereon. In a part of the light shielding film 34 omitted in FIG. 1, as illustrated in FIG. 3, an aperture portion 36 is formed. Light is allowed to pass when the above-mentioned aperture portion 16 of the shutter 14 and the aperture portion 36 of the light shielding film 34 communicate with each other, and light is blocked when the aperture portion 36 of the light shielding film 34 is covered due to the movement of the shutter 14. In other words, the shutter 14 is mechanically driven so as to control the passage and blocking of light through the aperture portion 36 of the light shielding film 34. One aperture portion 16 of the shutter 14 and one aperture portion 36 of the other light transmissive substrate 12 corresponding to each other constitute one pixel, and an image is displayed by a large number of pixels. Therefore, a plurality of (large number of) shutters 14 are provided to the light transmissive substrate 10.

The pair of light transmissive substrates 10 and 12 are adhered and fixed so as to be opposed to each other at a predetermined interval by a sealing member 38 illustrated in FIG. 1. The sealing member 38 is brought into close contact with the pair of light transmissive substrates 10 and 12. Further, with the sealing member 38, an encapsulation space is defined between the pair of light transmissive substrates 10 and 12. Therefore, the sealing member 38 is arranged so as to surround a display region of the display device, for example, in the vicinity of end portions of the pair of rectangular light transmissive substrates 10 and 12. Further, at a portion of the sealing member 38 arranged so as to surround the display region, there is formed an injection hole (not shown) for injecting oil to be described later.

The encapsulation space is filled with oil 42. That is, the oil 42 is filled inside the encapsulation space. The oil 42 is preferred to be, for example, silicone oil. The shutter 14 and the drive portion 40 are arranged in the oil 42. The oil 42 can suppress vibrations caused by the movement of the shutter 14 and the drive portion 40. That is, through filling of the oil 42 in the panel, it is possible to suppress vibration noise of the shutter 14 and the drive portion 40.

Further, through filling of the oil 42 in the panel, the dielectric constant increases, and the drive voltage applied to cause the shutter to move by the electrostatic attractive force can be reduced. Specifically, an inner energy U of a capacitance C of parallel plates applied with a voltage V is represented by U=½(CV²). A force F acting between the parallel plates, which is obtained by substituting V=Ed (E: electric field between the plates, d: distance) and C=∈S/d (S: area of the plate, ∈: dielectric constant between the plates) into the above-mentioned expression, is represented by F=U/d=½(∈SE²). Thus, the dielectric constant and the force applied between the plates are in a proportional relationship. That is, V=(F·d²/2∈S)^{1/2} is satisfied, and in a case where the force F acting between the parallel plates is the same, when the dielectric constant increases, only application of a small voltage is required. Therefore, when the dielectric constant between the first spring 20 and the second spring 32 (that is, the dielectric constant in a region filled with the oil 42) increases, the drive voltage necessary for obtaining the predetermined force F which enables the shutter 14 to move is reduced.

As described above, in a conventional display device in which the inside of the panel (encapsulation space, that is, region filled with the oil 42) is filled with oil, there has been a problem that air bubbles are generated inside the panel. It is conceived that the air bubbles are generated for the following reason. For example, when the oil 42 contracts due to decrease of the environmental temperature, the volume of the oil 42 reduces, but the encapsulation space is surrounded by the sealing member 38, and hence the volume of the encapsulation space does not reduce so much as compared to the volume reduction amount of the oil 42. That is, because the volume reduction amount (contraction amount) of the oil 42 is larger than the volume reduction amount of the encapsulation space, air bubbles are generated inside the panel.

Note that, also in a known liquid crystal display device, the sealing member defines the encapsulation space between the pair of insulating substrates, and further liquid crystal is filled in the encapsulation space. However, in the liquid crystal display device, a gap of the liquid crystal layer (that is, the thickness of the encapsulation space) is an important element for determining the optical characteristics thereof. Therefore, the liquid crystal display device is manufactured so that the gap of the liquid crystal layer is not varied as much as possible. For example, in the liquid crystal display device, there is formed a spacer which hardly thermally-expands or thermally-contracts due to the change of the environmental temperature, and thus the gap of the liquid crystal layer is controlled.

That is, because the optical characteristics change, the liquid crystal display device does not employ the method as in this embodiment in which the volume of the encapsulation space is intentionally changed by thermal expansion or thermal contraction of the sealing member in accordance with the volume change of the filling material (oil 42 in this embodiment and liquid crystal in the liquid crystal display device) inside the encapsulation space.

In a first embodiment of the present invention, a thermal expansion coefficient α of the sealing member 38 is larger than a thermal expansion coefficient β of the oil 42. Therefore, for example, when the environmental temperature decreases, the volume of the oil 42 reduces. In addition, the sealing member 38 having the thermal expansion coefficient larger than that of the oil 42 contracts. Thus, the volume of the encapsulation space reduces by an amount equivalent to the volume reduction amount of the oil 42, and hence it is possible to prevent generation of the air bubbles inside the panel. Note that, considering the stability of the panel shape, it is desired that the thermal expansion coefficient α of the sealing member 38 be in a range equal to or smaller than 1.2 times the thermal expansion coefficient β of the oil 42.

### Second Embodiment

In a second embodiment of the present invention, the thermal expansion coefficient α of the sealing member 38 and the thermal expansion coefficient β of the oil 42 are set equal to each other. Also in this case, similarly to the first embodiment, for example, when the environmental temperature decreases, the volume of the oil 42 reduces. In addition, the sealing member 38 having the thermal expansion coefficient equal to that of the oil 42 contracts. Thus, the volume of the encapsulation space reduces by an amount equivalent to the volume reduction amount of the oil 42, and hence it is possible to prevent generation of air bubbles inside the panel.

### Third Embodiment

In a third embodiment of the present invention, the thermal expansion coefficient α of the sealing member 38 and the thermal expansion coefficient β of the oil 42 are set to satisfy a relationship of 0.8β≦α≦1.2β. The inventors of the present invention have found that, when a difference between the thermal expansion coefficient α of the sealing member 38 and the thermal expansion coefficient β of the oil 42 is reduced within a range satisfying the above-mentioned relationship, it is possible to sufficiently prevent generation of air bubbles at a level which does not cause a trouble to the display device characteristics. For example, the thermal expansion coefficient of silicone oil is about 1,340 ppm/K. When the silicone oil is used as the oil 42, the sealing member 38 is made of a material having the thermal expansion coefficient in a range of 1,072 ppm/K or larger and 1,608 ppm/K or smaller.

In the third embodiment, as described above, the difference between the thermal expansion coefficient α of the sealing member 38 and the thermal expansion coefficient β of the oil 42 is small. Therefore, when the environmental temperature decreases, the sealing member 38 contracts in accordance with the contraction of the oil 42, and the encapsulation space contracts in accordance with the contraction of the sealing member 38. Therefore, the difference in volume between the encapsulation space and the oil 42 reduces, and hence it is possible to prevent generation of air bubbles inside the panel.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device, comprising:
a pair of insulating substrates which are arranged so as to be opposed to each other at an interval;
a sealing member for adhering the pair of insulating substrates to each other;
a shutter formed on one of the pair of insulating substrates;
an encapsulation space defined by the pair of insulating substrates and the sealing member; and
oil filled in the encapsulation space,
wherein the shutter is arranged in the encapsulation space, and
wherein the sealing member has a thermal expansion coefficient larger than a thermal expansion coefficient of the oil.

2. The display device according to claim 1, wherein the thermal expansion coefficient of the sealing member is equal to or smaller than 1.2 times the thermal expansion coefficient of the oil.

3. A display device, comprising:
a pair of insulating substrates which are arranged so as to be opposed to each other at an interval;
a sealing member for adhering the pair of insulating substrates to each other;
a shutter formed on one of the pair of insulating substrates;
an encapsulation space defined by the pair of insulating substrates and the sealing member; and
oil filled in the encapsulation space,
wherein the shutter is arranged in the encapsulation space, and
wherein the sealing member has a thermal expansion coefficient equal to a thermal expansion coefficient of the oil.

4. A display device, comprising:
a pair of insulating substrates which are arranged so as to be opposed to each other at an interval;
a sealing member for adhering the pair of insulating substrates to each other;
a shutter formed on one of the pair of insulating substrates;
an encapsulation space defined by the pair of insulating substrates and the sealing member; and
oil filled in the encapsulation space,
wherein the shutter is arranged in the encapsulation space, and
wherein the following relationship is satisfied,
0.8β≦α≦1.2β,
where α represents a thermal expansion coefficient of the sealing member and β represents a thermal expansion coefficient of the oil.

5. The display device according to claim 1, wherein the oil comprises silicone oil.

6. The display device according to claim 1, wherein the shutter is movable.

7. The display device according to claim 6, further comprising:
a first spring;
a second spring;
a first anchor portion; and
a second anchor portion,
the first spring, the second spring, the first anchor portion, and the second anchor portion being formed on the one of the pair of insulating substrates,
the first spring being connected to the first anchor portion,
the second spring being connected to the second anchor portion,
wherein the shutter is connected to the first spring and to the first anchor portion via the first spring, and
wherein the shutter is driven by an electrostatic attractive force generated by a potential difference between the first spring and the second spring.

8. The display device according to claim 7, wherein the shutter has a main surface, which is supported by the first spring and the first anchor portion and is arranged apart from a main surface of the one of the pair of insulating substrates.

9. The display device according to claim 1, further comprising a light shielding film formed on another of the pair of insulating substrates, which is different from the one of the pair of insulating substrates,
wherein the light shielding film comprises a plurality of first aperture portions.

10. The display device according to claim 9, further comprising a backlight unit arranged so as to be opposed to the pair of insulating substrates,
wherein each of the pair of insulating substrates comprises a display region opposed to at least a part of the encapsulation space,
wherein the shutter has a main surface, which comprises a second aperture portion, and
wherein light emitted from the backlight unit to enter the pair of insulating substrates passes through one of the plurality of first aperture portions, and the second aperture portion to exit from the display region.

11. The display device according to claim 3, wherein the oil comprises silicone oil.

12. The display device according to claim 3, wherein the shutter is movable.

13. The display device according to claim 12, further comprising:
a first spring;
a second spring;
a first anchor portion; and
a second anchor portion,
the first spring, the second spring, the first anchor portion, and the second anchor portion being formed on the one of the pair of insulating substrates,
the first spring being connected to the first anchor portion,
the second spring being connected to the second anchor portion,
wherein the shutter is connected to the first spring and to the first anchor portion via the first spring, and
wherein the shutter is driven by an electrostatic attractive force generated by a potential difference between the first spring and the second spring.

14. The display device according to claim 13, wherein the shutter has a main surface, which is supported by the first spring and the first anchor portion and is arranged apart from a main surface of the one of the pair of insulating substrates.

15. The display device according to claim 3, further comprising a light shielding film formed on another of the pair of insulating substrates, which is different from the one of the pair of insulating substrates,
wherein the light shielding film comprises a plurality of first aperture portions.

16. The display device according to claim 15, further comprising a backlight unit arranged so as to be opposed to the pair of insulating substrates,
wherein each of the pair of insulating substrates comprises a display region opposed to at least a part of the encapsulation space,
wherein the shutter has a main surface, which comprises a second aperture portion, and
wherein light emitted from the backlight unit to enter the pair of insulating substrates passes through one of the plurality of first aperture portions, and the second aperture portion to exit from the display region.

17. The display device according to claim 4, wherein the oil comprises silicone oil.

18. The display device according to claim 4, wherein the shutter is movable.

19. The display device according to claim 18, further comprising:
a first spring;
a second spring;
a first anchor portion; and
a second anchor portion,
the first spring, the second spring, the first anchor portion, and the second anchor portion being formed on the one of the pair of insulating substrates,
the first spring being connected to the first anchor portion,
the second spring being connected to the second anchor portion,
wherein the shutter is connected to the first spring and to the first anchor portion via the first spring, and
wherein the shutter is driven by an electrostatic attractive force generated by a potential difference between the first spring and the second spring.

20. The display device according to claim 19, wherein the shutter has a main surface, which is supported by the first spring and the first anchor portion and is arranged apart from a main surface of the one of the pair of insulating substrates.

21. The display device according to claim 4, further comprising a light shielding film formed on another of the pair of insulating substrates, which is different from the one of the pair of insulating substrates,
wherein the light shielding film comprises a plurality of first aperture portions.

22. The display device according to claim 21, further comprising a backlight unit arranged so as to be opposed to the pair of insulating substrates,
wherein each of the pair of insulating substrates comprises a display region opposed to at least a part of the encapsulation space,
wherein the shutter has a main surface, which comprises a second aperture portion, and
wherein light emitted from the backlight unit to enter the pair of insulating substrates passes through one of the plurality of first aperture portions, and the second aperture portion to exit from the display region.
